(19) United States
(12) Patent Application Publication
(10) Pub. No.: US 2025/0060269 A1
(43) Pub. Date: Feb. 20, 2025

(54) AUTOMATIC TRANSMISSION LEAK TESTER PLATE

(71) Applicant: Timothy D. Northcutt, Sterrett, AL (US)

(72) Inventor: Timothy D. Northcutt, Sterrett, AL (US)

(21) Appl. No.: 18/234,655

(22) Filed: Aug. 16, 2023

(51) Int. Cl. G01M 3/02; G01M 15/02

(52) U.S. Cl. CPC G01M 3/02; G01M 15/02

(57) ABSTRACT

A leak test adapter plate that allows the user to test an automatic transmission for internal leaks using a shop air gun. To use the leak test adapter plate, a valve body is removed from the transmission and the test plate is bolted on. Each transmission line to be tested has an associated hole in the test plate, through which the shop air gun is used to test the respective lines.

### SUMMARY

A leak test adapter plate that allows a user to test an automatic transmission for internal leaks using a shop air gun.

### DETAILED DESCRIPTION

In the following description, numerous specific details are set forth to clearly describe the embodiments disclosed herein. However, one skilled in the art will understand that some well known features have not been described in detail so as not to obscure the invention.

In the following description, like reference numbers are used to identify like elements. Furthermore, the drawings are intended to illustrate major features of the exemplary embodiments in a diagrammatic manner. The drawings are not intended to depict every feature of every implementation and are not drawn to scale.

### BRIEF DESCRIPTION OF FIGURES

FIG. 1: overhead view of leak test adapter plate

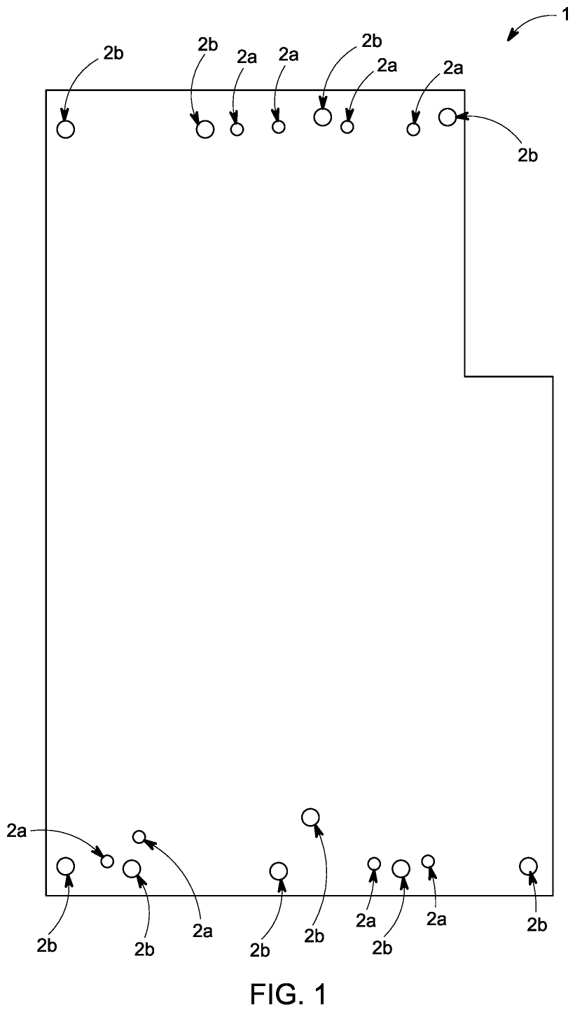

The leak test adapter plate (1) has holes (2a, 2b) oriented and sized to permit the test plate to be bolted into place and the use of a shop air gun to test an automatic transmission for leaks.

The preferred embodiment, already in use by the inventor, has dimensions selected to be appropriate for testing the 722.6 Mercedes-Benz automatic transmission. To use the test plate, the user removes a valve body from the automatic transmission being tested and bolts the test plate in place. The user then uses the shop air gun to test each shift element or transmission line line previously attached to the valve body which has been removed, with each hole in the test plate corresponding in position to an associated transmission line or shift element after bolting into place. This permits the user to detect leaking seals inside the transmission.

While illustrative embodiments of the invention have been shown and described, variations and alternative embodiments will occur to those skilled in the art. Such variations and alternative embodiments can be made without departing from the scope of the invention as defined in the claims. In particular, while the described and illustrated structure is for testing the 722.6 Mercedes-Benz automatic transmission, the use of a leak test adapter plate for other models of automatic transmission is encompassed by the invention.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom. Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”.

1. A leak test adapter plate, comprising:
a plate; and
at least two sets of holes in the plate;
wherein the plate and the at least two sets of holes in the plate have dimensions and are configured such that the plate may be bolted into place after removing the body of a valve of an automatic transmission system, and permit the testing of individual shift elements for leaks using a shop air gun.

2. The leak test adapter plate of claim 1, wherein the automatic transmission the leak test adapter plate is configured to permit testing of is the 722.6 Mercedes-Benz automatic transmission.

3. A method of using a leak test adapter plate, comprising:
first, removing a valve body from an automatic transmission;
second, bolting the leak test adapter plate onto the automatic transmission; and
third, testing each shift element of the automatic transmission through the holes of the leak test adapter plate by using a shop air gun to impart pressure to each shift element, one at a time.
